(19) United States
(12) Patent Application Publication
(10) Pub. No.: US 2015/0248702 A1
(43) Pub. Date: Sep. 3, 2015

(54) PROXIMITY-BASED VISUAL NOTIFICATIONS

(71) Applicant: EBAY INC., San Jose, CA (US)

(72) Inventor: Geoffrey W. Chatterton, Los Altos, CA (US)

(21) Appl. No.: 14/195,595

(22) Filed: Mar. 3, 2014

(51) Int. Cl. G06Q 30/02; H04W 4/00

(52) U.S. Cl. CPC G06Q 30/0261; H04W 4/008; G06Q 30/0271

(57) ABSTRACT

Systems and methods are provided for providing users with proximity-based visual notifications or advertisements. The provided systems and methods may use a beacon installed at a location and in communication with a display component to communicate with a mobile device of a user in proximity to the beacon to determine if any advertisements or notifications available to the beacon match any user preferences for receiving advertisements or notifications. The communications with the mobile device may be made without user input, and may only require initial user set up to set their preferences. The communications between the mobile device and the beacon may be performed using a Bluetooth® low energy (BLE) communications protocol or other wireless networking protocol.

### BACKGROUND

1. Technical Field

Embodiments disclosed herein are related to systems and methods for providing targeted and personalized proximity-based visual notifications to a user.

2. Related Art

Merchants and other proprietors have long relied on advertising to promote their brand, product, store, or location. The advertising is typically delivered to consumers using traditional media, such as newspapers, television, and the like. Most of the advertising, however, is designed for large groups of people, and is not tailored for individual people.

With the rise in the use of personal mobile devices, merchants have recognized another media on which to deliver an advertisement or other notification, such as an offer or special. For example, when a consumer visits a merchant location, the consumer may provide an update on social media or check in to the location using a check in service. The merchant may see the consumer based on the update or check in, and send an advertisement or notification to the user via a push notification, a short messaging service (SMS) message, and the like, allowing the merchant to provide advertising and notifications to the user via the mobile device. In some cases, the merchant may be able to tailor the advertisement or notification to the user.

However, providing advertisements and other notifications to a consumer's mobile device requires that the consumer actively perform an action such as provide a social media update or check in. Moreover, in order to see the advertisement or notification, the consumer is required to take out their personal mobile device and, in some cases, perform additional interactions with the personal mobile device to view the advertisement or notification. Since many consumers do not always perform an action such as providing a social media update or check in, the merchants are missing out on a large audience of consumers who have personal mobile devices but are not using them at the merchant location. Moreover, consumers who receive a notification may not know that the notification has been received if their personal mobile device is in a silent or private mode, or they just may not want to go through the trouble of taking their personal mobile device out to view the advertisement or notification. Consequently, a merchant may not be able to reach many consumers with advertisements or notifications.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIG. 3 is a diagram illustrating a beacon, consistent with some embodiments.

FIG. 4 is a diagram illustrating a location having multiple beacons throughout the location.

FIG. 5 is a diagram illustrating a first flow for presenting a proximity-based visual notification to a user, consistent with some embodiments.

FIG. 6 is a diagram illustrating a second flow for presenting a proximity-based visual notification to a user, consistent with some embodiments.

FIG. 7 is a diagram illustrating a third flow for presenting a proximity-based visual notification to a user, consistent with some embodiments.

FIG. 8 is a diagram illustrating a fourth flow for presenting a proximity-based visual notification to a user, consistent with some embodiments.

FIG. 9 is a flowchart illustrating a process for providing a proximity-based visual advertisement or notification, consistent with some embodiments.

FIG. 10 is a flowchart illustrating a process for providing user preferences and/or an advertisement or notification to a beacon, consistent with some embodiments.

FIG. 11 is a flowchart illustrating a process for providing an advertisement or notification to a display component for presentation to a user, consistent with some embodiments.

FIG. 12 is a flowchart illustrating a process for providing an advertisement or notification to a display component for presentation to a user, consistent with some embodiments.

FIG. 13 is a flowchart of an exemplary method of facilitating payment or credit for a purchase by utilizing an automated wireless consumer checkin according to some embodiments.

FIG. 14 is a flowchart of an exemplary method of performing a handshake between a beacon and a purchaser mobile device on an unencrypted channel so as to facilitate a payment or credit for a purchase according to some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

What is needed are systems and methods for providing targeted notifications and/or advertisements to a user at a location without requiring the user to actively use a device to receive the notifications and/or advertisements.

Consistent with some embodiments, there is provided a system. The system includes one or more wireless transceivers configured to periodically send one or more messages including available notifications. The system also includes one or more processors configured to determine when a request for an available notification matching user preferences is received from a user device in communication with the one or more wireless transceivers and determine a matching notification to present to the user, and a network interface component configured to retrieve the determined notifications. The system further includes a memory configured to store the retrieved notifications; and a video apparatus coupled to the memory and configured to display the retrieved notifications.

Consistent with some embodiments, there is also provided a method including steps of periodically sending one or more messages including available notifications, determining at least one notification to present to a user based on a request received from a user device for a notification matching user preferences, retrieving and storing the determined notification, and displaying the retrieved notification to the user. The provided method may be embodied in computer-readable media.

Consistent with some embodiments, there is further provided a method including steps of storing preferences for receiving advertisements entered by a user, determining when at least one available advertisement received from a beacon matches the stored preferences, and initiating communication with the beacon and requesting a matching advertisement when at least one available advertisement received from the beacon matches the stored preferences. The provided method may be embodied in computer-readable media.

Embodiments disclosed herein may allow targeted advertisements or notifications to be presented to a user in the proximity of a wireless device having or being coupled to a display based on defined user preferences for receiving advertisements or notifications.

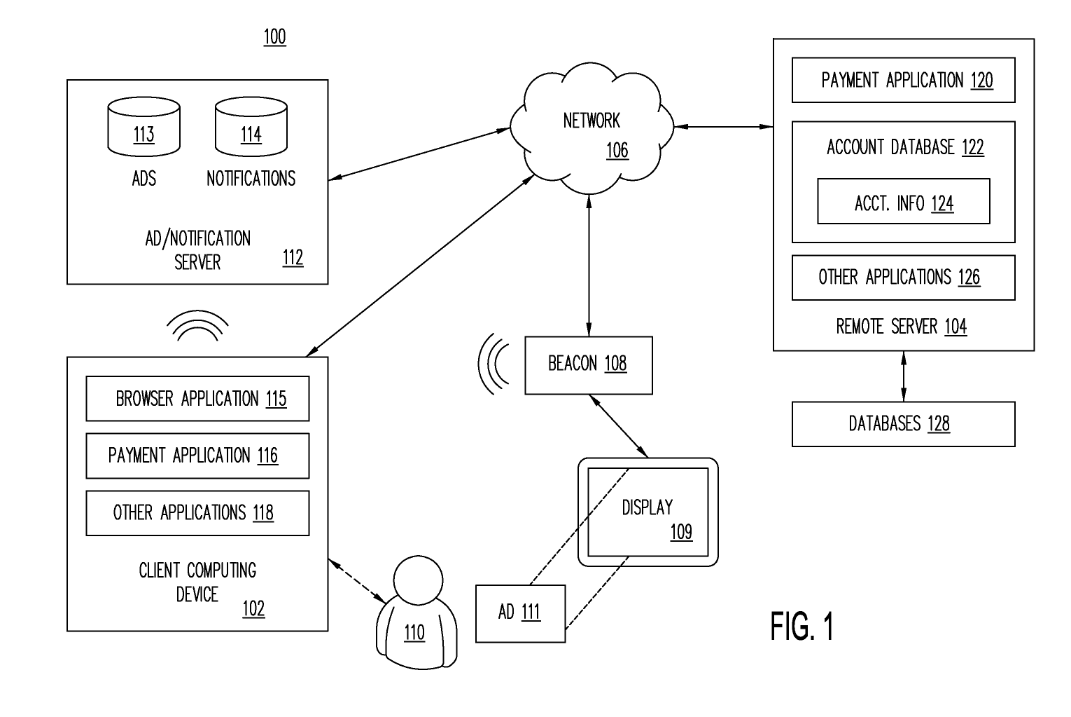

FIG. 1 is a block diagram of a networked system 100, consistent with some embodiments. System 100 includes a client computing device 102 and a remote server 104 in communication over a network 106. Remote server 104 may be a payment service provider server that may be maintained by a payment service provider, such as PayPal, Inc. of San Jose, Calif. Remote server 104 may be maintained by other service providers in different embodiments. Remote server 104 may also be maintained by an entity with which sensitive credentials and information may be exchanged with client computing device 102. Remote server 104 may be more generally a web site, an online content manager, a service provider, such as a bank, or other entity who provides content to a user requiring user authentication or login.

Network 106, in one embodiment, may be implemented as a single network or a combination of multiple networks. For example, in various embodiments, network 106 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Client computing device 102, in one embodiment, may be implemented using any appropriate combination of hardware and/or software configured for wired and/or wireless communication over network 106. For example, client computing device 102 may be implemented as a wireless telephone (e.g., smart phone), tablet, personal digital assistant (PDA), notebook computer, personal computer, a connected set-top box (STB) such as provided by cable or satellite content providers, or a video game system console, a head-mounted display (HMD) or other wearable computing device, including a wearable computing device having an eyeglass projection screen, and/or various other generally known types of computing devices.

As shown in FIG. 1, system 100 may include one or more beacons 108 coupled to one or more display apparatuses 109. In some embodiments, beacons 108 may be installed at a merchant location, such as a store, restaurant, and the like. In some embodiments, beacons 108 may be Bluetooth™ Low Energy (BLE) beacons. BLE is a technology that transmits information at a frequency of about 2.4 GHz (about 2042-2480 MHz) over forty (40) 2-MHz wide channels, and has a range of about 50 meter or about 160 feet. Information transmitted according to the BLE protocol may be transmitted at a rate of about 1 Mbit/s with an application throughput of about 0.27 Mbit/s. In some embodiments, BLE communications may be secured using 128-bit Advanced Encryption Standard (AES) encryption with counter mode with a cipher block chaining message authentication code (CBC-MAC) and user defined security. Further, in some embodiments, BLE communications may utilize adaptive frequency hopping, lazy acknowledgement, a 24-bit cyclic redundancy check (CRC) and 32-bit message integrity check for robustness. Moreover, in some embodiments, BLE-capable devices may consume a fraction of the power of standard Bluetooth® devices due to the protocol allowing low duty cycles, and being designed for applications that may not require continuous data transfer. Beacons 108 may transmit one or more sequences of information such that when a device such as client computing device 102 capable of receiving information from beacons 108 comes within the range of a beacon 108, the device may receive a transmission from a beacon 108 and be instructed to perform an action, such as display an advertisement, execute a payment application, or check a user 110 in to a particular location. Beacons 108 may also be capable of receiving one or more sequences of information according to the BLE communications protocol from client computing device 102. In some embodiments, beacon 108 may be in communication with remote server 104 over network 106 through wireless or wired connection. In other embodiments, beacons 108 may be capable of sending and receiving information according to other wireless communications protocols, such as Wi-Fi™, ZigBee®, ANT or ANT+, radio frequency identification (RFID), and other such protocols that have a limited range capable of localizing user 110 to a predetermined proximity in which an advertisement or notification can be presented to user 110.

Display component 109 may be any apparatus capable of displaying a visual advertisement or notification 111 to user 110, wherein advertisement or notification 111 may refer to an advertisement, a notification, an offer, an incentive, or a combination thereof. As used herein, an advertisement may be a type of notification. In some embodiments, display component 109 may be a monitor such as a liquid crystal display (LCD) screen, an organic light emitting diode (OLED) screen (including active matrix AMOLED screens), an LED screen, a plasma display, a cathode ray tube (CRT) monitor, or an electronic ink (e-Ink) display. In some embodiments, display component 109 may be a projection device capable of projecting advertisement or notification 111 for viewing by user 110, such as a Digital Light Processing (DLP) projector, a laser beam-steering (LBS) projector, a liquid crystal on silicon (LCoS) projector, a mobile or portable projector. Display component 108 may also be capable of providing a visual light display, such as a light emitting diode (LED) display, or a laser galvanometer capable of drawing a visual notification using lasers.

Display component is 109 may be coupled to beacon 108 to receive advertisement or notification 111 from beacon 108. In some embodiments, display component 109 may be coupled to beacon 108 via a wired or wireless coupling. In some embodiments, display component 109 may be coupled to beacon 108 via a plug in coupling with beacon 108 plugging into a port, such as a Universal Serial Bus (USB) port, a High Definition Multimedia Interface (HDMI) port, and the like on display component 109, or vice versa. In further embodiments, display component 109 may be coupled to beacon 108 via a bus such that display component 109 and beacon 108 are part of the same device, such as a beacon having display or projection abilities.

System 100 may also include an advertisement or notification server 112 coupled to beacon 108 over network 106. In some embodiments, advertisement or notification server 112 may store advertisements 113 and notifications 114 that may be retrieved by beacon 108, where they may be stored and the provided to display component 109 for providing to user 110 for viewing. In some embodiments, advertisement or notification server 112 may be maintained by a merchant or location proprietor associated with beacon 108. Advertisement or notification server 112 may also be maintained by a third party, such as a third party clearinghouse for advertisements and notifications. In some embodiments, advertising or notification server 112 may be capable of personalizing advertisements or notifications retrieved from server 112 for user 110.

In some embodiments, client computing device 102 may be a simple wireless device, such as an RFID transmitter, capable of sending information to one or more RFID readers in range of client computing device 102. In other embodiments, client computing device 102 may include any appropriate combination of hardware and/or software having one or more processors and capable of reading instructions stored on a tangible non-transitory machine-readable medium for execution by the one or more processors. Consistent with some embodiments, client computing device 102 includes a machine-readable medium, such as a memory (not shown) that includes instructions for execution by one or more processors (not shown) for causing client computing device 102 to perform specific tasks. In some embodiments, the instructions may be executed by the one or more processors in response to interaction by user 110. For example, such instructions may include browser application 115 such as a mobile browser application, which may be used to provide a user interface to permit user 110 to browse information available over network 106, including information hosted by remote server 104. For example, browser application 115 may be implemented as a web browser to view information available over network 106. Browser application 115 may include a graphical user interface (GUI) that is configured to allow user 110 to interface and communicate with remote server 104 or other servers managed by content providers or merchants via network 106. For example, user 110 may be able to access websites to find and purchase items, as well as access user account information or web content.

Client computing device 102 may also include a payment application 116 that may be used by user 110 using client computing device 102 to make a payment. In some embodiments, payment application 116 may be configured to make a payment using remote server 104 as a payment processor. Payment application 116 may further be configured to make a payment by transmitting information to beacon 108 using a BLE communications protocol, wherein beacon 108 may then transmit information to remote server for processing the payment, such as described in U.S. patent application Ser. No. 13/938,860, filed on Jul. 10, 2013, and U.S. patent application Ser. No. 14/021,045, filed on Sep. 9, 2013, the entire contents of both of these applications which are hereby incorporated by reference in their entirety. Payment application 116 may further be capable of and configured to transmit information about user 110 using a wireless protocol. Such information may include advertisement or notification preferences, which may indicate the type, frequency, time, and subject of advertisements or notifications that user 110 may want to receive, and may be set by user 110 using payment application 116. This information may be sent by client computing device 102 in response to query for such information. In some embodiments, this information may be periodically sent from client computing device 102 via announcement or advertisement form client computing device 102. Moreover, client computing device 102 may store such information and compare available advertisements or notifications received from beacon 108 to determine if any of the available advertisements or notifications match user information including user preferences. Client computing device 102 may be capable of communicating with beacon 108 to request such a matching advertisement.

Client computing device 102 may include other applications 118 as may be desired in one or more embodiments to provide additional features available to user 110, including accessing a user account with remote server 104. For example, applications 118 may include interfaces and communication protocols that allow the user to receive and transmit information through network 106 and to remote server 104 and other online sites. Applications 118 may also include security applications for implementing client-side security features, programmatic client applications for interfacing with appropriate APIs over network 106 or various other types of generally known programs and/or applications. Applications 116 may include mobile applications downloaded and resident on client computing device 102 that enables user 110 to access content through the applications.

Remote server 104, according to some embodiments, may be maintained by an online payment provider, such as PayPal, Inc. of San Jose, Calif., which may provide processing for online financial and information transactions on behalf of user 110. Remote server 104 may also be capable of providing access to a merchant's goods and services (collectively referred to as “items”) that are for purchase and may provide a payment service processing for the purchased items. Remote server 104 may include at least a payment application 120 that may facilitate processing payments for user 110 to merchants, for example. In some embodiments, payment application 120 may be configured to interface with payment application 116 to receive payment details, user information, merchant information, and additional information for processing a payment on behalf of user 110. Payment application 120 may also be capable of interfacing with beacon 108 for receiving information transmitted to beacon 108 by client computing device 102 using a wireless communications protocol. Remote server 104 may also include an account database 122 that includes account information 124 for users having an account on remote server 104, such as user 110. In some embodiments, payment application 120 may process payments based on information in account information 124 of account database 122. In some embodiments, account information 124 may include information about user 110 such as advertisement or notification preferences, which may indicate the type, frequency, time, and subject of advertisements or notifications that user 110 may want to receive. Account information 124 may also include purchases made by user 110 processed by remote server 104, including items purchased, that may be used to determine advertisement or notification preferences. Remote server 104 may include other applications 126 and may also be in communication with one or more external databases 128, that may provide additional information that may be used by remote server 104. In some embodiments, databases 128 may be databases maintained by third parties, and may include third party account information of user 110.

As explained in the aforementioned patent application Ser. No. 14/021,045 (published on Jul. 3, 2014 as US 2014/0188733 A1), the foregoing networks, systems, devices, methods and variations thereof can be used to implement an automated checkin of users at a cooperating or subscribing establishment, such that subsequent purchase transactions and other activities can be more streamlined and convenient. Rather than having users resort to known procedures involving wireless checkins with their own personal mobile devices at a point of sale, a more user friendly system involving the use of Bluetooth Low Energy (“BLE”) in association with separate user phones, other mobile devices or any suitable user computing devices can be provided. One or more applications or “apps” can be provided for download and use on private consumer phones and mobile devices to help facilitate the use of the automated checkin process. In various embodiments, such automated checkins can be facilitated by a transaction service provider, such as, for example, PayPal Inc. of San Jose, Calif.

Bluetooth low energy (“BLE”) is a relatively new feature of Bluetooth 4.0 wireless radio technology. BLE is intended for primarily low-power and low-latency applications for wireless devices within a short range, such as up to about 50 meters. Devices using BLE utilize a protocol having intermittent communications, smaller amounts of data transfer and bandwidths, as well as low duty cycles. As such, BLE can consume only a fraction of the power of traditional Bluetooth enabled products for Bluetooth communications. In many cases, BLE products will be able to operate more than a year on a tiny battery without recharging. The use of BLE can allow for a wider variety of applications in relatively low power devices, such as smart phones and other personal mobile devices.

In various embodiments, it is specifically contemplated that personal smart phones and other mobile devices that are equipped with BLE capabilities can be provided with programs or “apps” that leverage the use of these capabilities to allow for the automated checkins of owners or users carrying those devices when they are merely in or at a participating establishment. BLE allows for constant passive scanning for Bluetooth peripherals. A suitable program or app on a user device can be set to run frequently in the background under a BLE protocol, always monitoring for a significant change in location and/or presence of an appropriate BLE peripheral at a merchant or vendor. When the owner or user of the phone or personal mobile device enters a store or other participating location, he or she would pass by a BLE peripheral by the entrance or at some other appropriate location. This merchant or third party run BLE peripheral can be sending out a signal, such as for advertising a checkin service with a universally unique identifier (“UUID”) and store information.

It is worth noting that the communication process between the beacon and the purchaser smart phone or other mobile device can take place on an unencrypted channel. This is significant in that the communications between the devices actually involve a financial transaction, the details of which can be detected by any party due to the unencrypted nature of the communication. While the use of an unencrypted channel provides greater speed and flexibility for the use of many different devices, certain precautions should be taken to protect the sensitive nature of the financial or other consumer transaction. This can be accomplished by providing, for example, tokens for the devices to identify each other only in a generic fashion, with all sensitive information being retained remotely by a financial processing entity or other service provider. Also, since communications take place over unencrypted channels, there is no reason for a device to retain long term specific identifiers or information that is typically needed for bonded or encrypted communications.

The smart phone or other mobile user device would wirelessly detect or “see” this outside BLE peripheral due to the constant background running of the app under a BLE protocol. Once detection is made at a low or lowest energy level and duty cycle, a ramp up in energy, duty cycle, and/or other operating parameters can take place so that a handshake and checkin can take place automatically between the user device and the merchant device. In particular, the privately or separately owned mobile phone or other mobile user device can connect to the service at the store, merchant or other location, encrypt a payment token along with the beacon token and write it to the service. If the merchant possesses the necessary keys to decrypt the payment token, the information could then be decrypted and used directly by the merchant themself. Alternatively, the information may be passed by the peripheral or other component up to a remote third party payment provider, such as for example, PayPal. The third party provider can then decrypt the payment token and execute a checkin at the establishment on behalf of the customer or user. Later, when the customer or user approaches a checkout aisle or other point of sale, another BLE peripheral advertising a checkout service can be present. Various checks and processes can then take place based on the transmit power and received power of the BLE peripheral, mobile user device, or both, and the phone or other mobile device can again write credentials to the checkout service. This associates the customer with a particular register. Checkout can then proceed as normal for a checkin payment. In some embodiments, after an initial checkin, the mobile user device may be capable of advertising a one-time use UUID for a BLE peripheral. When the BLE peripheral receives the advertised UUID, the BLE would attempt to establish communications with the mobile device.

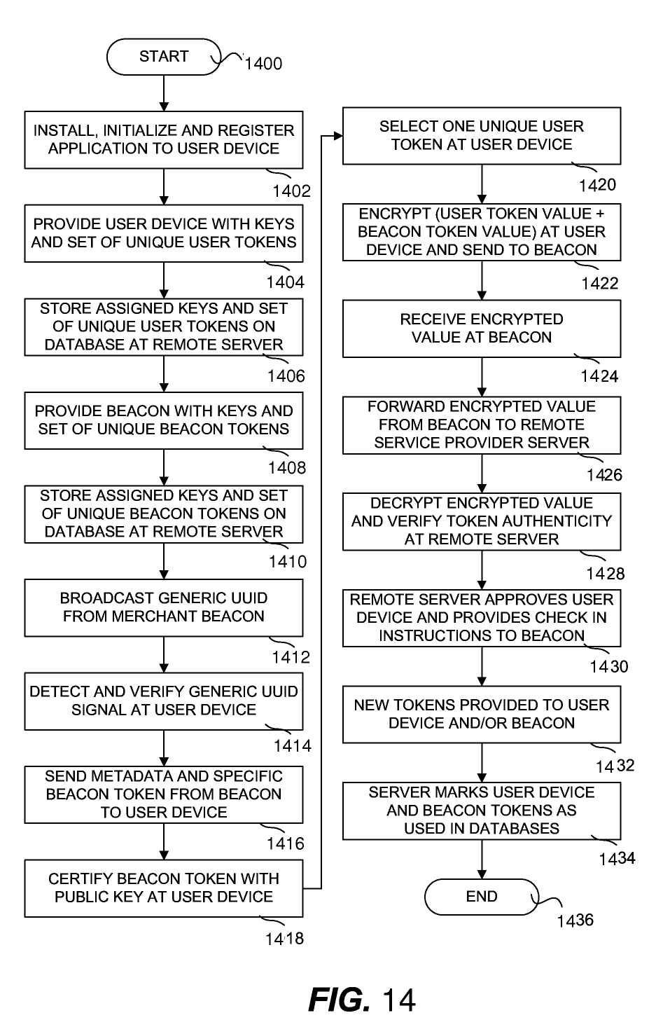

In order for the actual handshake and communication between the beacon and the user mobile device to be effective over an unencrypted channel, it is important that both devices already be initialized and signed up for the same remote third party service provider, such as Paypal or any other suitable provider. Each device can then be provided with public encryption keys, private encryption keys and payment tokens prior to meeting each other, such that the devices are able to recognize each other as belonging to the proper service when the signals are detected and the handshake begins. Information is then exchanged purely by way of keys and payment tokens, such that no sensitive information is ever exchanged over the unencrypted channel. Details of such key and token provisions, as well as the handshake process and protocols are provided below with respect to FIG. 14.

With the use of BLE and appropriate apps or programs on user devices, this entire process can be automated in many instances. This can save significant amounts of time and inconvenience for many consumers at the point of sale. In some embodiments, a beep, other sound, vibration, visual display or other output from the smart phone or other mobile user device can be provided upon automatic checkin. This can simply provide a notice to the user that they are now checked in at the establishment. Different sounds or indicators on a display can confirm to the user which establishment(s) the user is currently checked in, such as where malls or other locations having multiple vendors in a small area might be applicable. In this manner, a user can be made aware that he or she is checked in and is able to readily shop here and check out quickly.

In various further embodiments, other procedures can be implemented to take advantage of the knowledge that a user is at a given merchant location and that a purchase or other point of sale activity might be imminent. The bidirectional nature of BLE can allow for a more robust experience and interaction between the merchant, user, and/or third party payment service provider. For example, advertising and promotional offers can be directed to a known user from the merchant, the payment service provider, or both. These items can rely on a known history and other parameters applicable to the specific user. For example, notices can be provided regarding sales or promotions on items or related items that are known to be of interest or the subject of past purchases by a known user. Also, a step-up procedure to assess risk can be implemented, such that the user can be prompted for a PIN or other identifier if there is any concern over risk for that user or about a particular purchase. In addition, a customized offer of credit can be made for the user based upon various known factors in the associated customer account, history or profile. In various embodiments, a signal to the phone or device to buzz or emit a sound or display can be provided if the merchant or third party payment service provider might need a PIN or other verification at the time of purchase.

Although discussion has been made of applications on client computing device 102 and remote server 104, the applications may also be, in some embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by the applications.

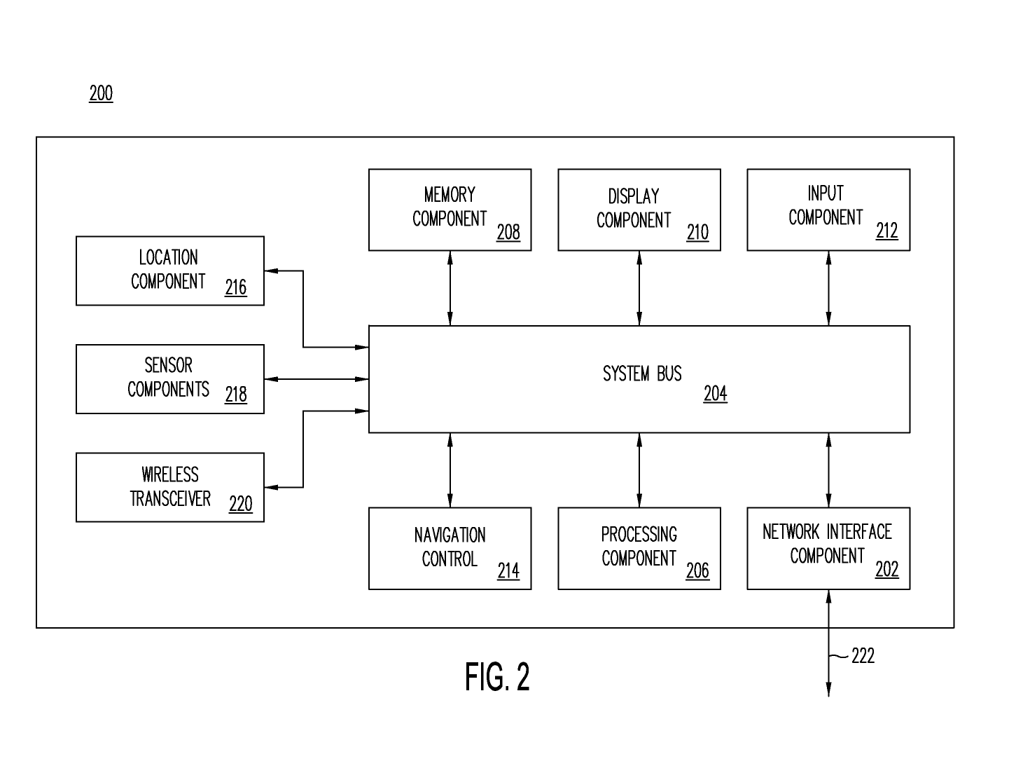

FIG. 2 is a diagram illustrating computing system 200, which may correspond to either of client computing device 102, remote server 104, or advertisement or notification server 112 consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as would be consistent with client computing device 102. Further, computing system 200 may also be a server or one server amongst a plurality of servers, as would be consistent with remote server 104 or advertisement or notification server 112. As shown in FIG. 2, computing system 200 includes a network interface component (NIC) 202 configured for communication with a network such as network 106 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 106. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Consistent with some embodiments, computing system 200 includes a system bus 204 for interconnecting various components within computing system 200 and communicating information between the various components. Such components include a processing component 206, which may be one or more processors, micro-controllers, graphics processing units (GPUs) or digital signal processors (DSPs), and a memory component 208, which may correspond to a random access memory (RAM), an internal memory component, a read-only memory (ROM), or an external or static optical, magnetic, or solid-state memory. Consistent with some embodiments, computing system 200 further includes a display component 210 for displaying information to a user 120 of computing system 200. Display component 210 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 212, allowing for a user of computing system 200, such as consumer 120, to input information to computing system 200. Such information could include payment information such as an amount required to complete a transaction, account information, authentication information such as a credential, or identification information. An input component 212 may include, for example, a keyboard or key pad, whether physical or virtual. Computing system 200 may further include a navigation control component 214, configured to allow a user to navigate along display component 210. Consistent with some embodiments, navigation control component 214 may be a mouse, a trackball, or other such device. Moreover, if device 200 includes a touch screen, display component 210, input component 212, and navigation control 214 may be a single integrated component, such as a capacitive sensor-based touch screen.

Computing system 200 may further include a location component 216 for determining a location of computing system 200. In some embodiments, location component 216 may correspond to a GPS transceiver that is in communication with one or more GPS satellites. In other embodiments, location component 216 may be configured to determine a location of computing system 200 by using an internet protocol (IP) address lookup, or by triangulating a position based on nearby telecommunications towers or wireless access points (WAPs). Location component 216 may be further configured to store a user-defined location in memory component 208 that can be transmitted to a third party for the purpose of identifying a location of computing system 200. Computing system 200 may also include sensor components 218. Sensor components 218 provide sensor functionality, and may correspond to sensors built into client computing device 102 or sensor peripherals coupled to client computing device 102. Sensor components 218 may include any sensory device that captures information related to user 110 and/or client computing device 102 that may be associated with any actions that user 110 performs using client computing device 102. Sensor components 218 may include camera and imaging components, accelerometers, biometric readers, GPS devices, motion capture devices, and other devices that are capable of providing information about client computing device 102 or user 110, or an environment therearound. Computing system 200 may also include one or more wireless transceivers 220 that may each include an antenna that is separable or integral and is capable of transmitting and receiving information according to one or more wireless network protocols, such as Wi-Fi™, 3G, 4G, LTE, RF, NFC, IEEE 802.11a, b, g, n, ac, or ad, Bluetooth®, BLE, WiMAX, ZigBee®, ANT or ANT+, etc.

Computing system 200 may perform specific operations by processing component 206 executing one or more sequences of instructions contained memory component 208. In other embodiments, hard-wired circuitry may be used in place of or in combination with software instructions to implement the present disclosure. Logic may be encoded in a computer readable medium, which may refer to any medium that participates in providing instructions to processing component 206 for execution, including memory component 208. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 222 to network 106 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 222 and network interface component 202 and wireless transceiver 220. Received program code may be executed by processing component 206 as received and/or stored in memory component 208.

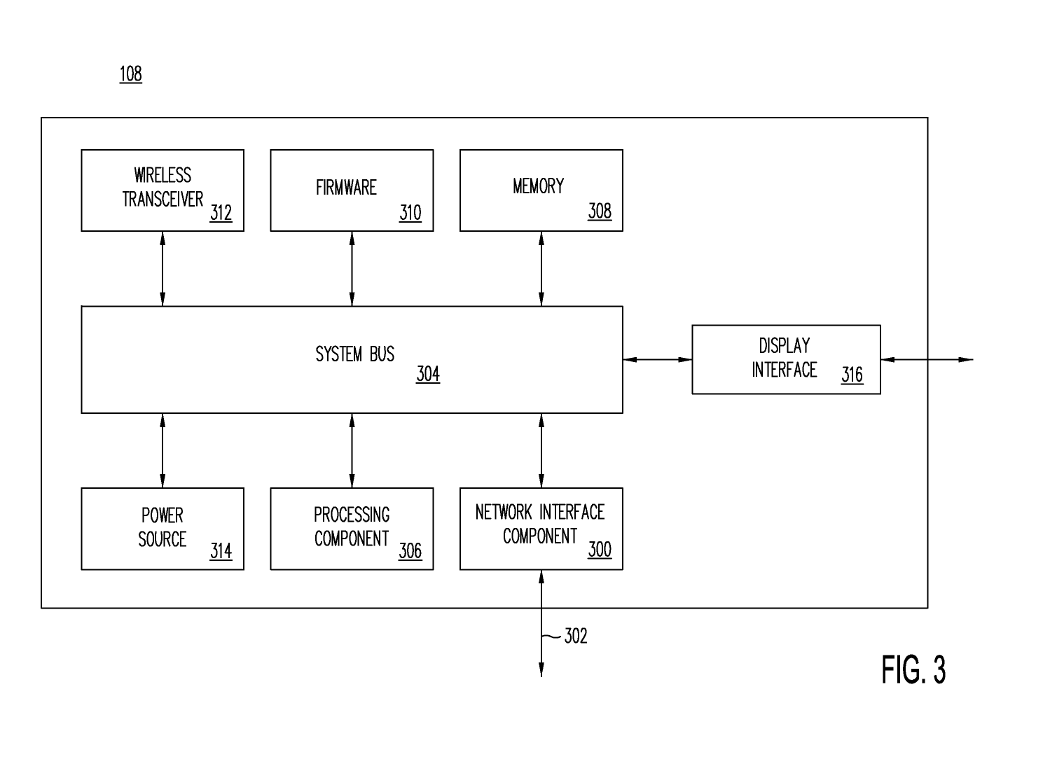

FIG. 3 is a diagram illustrating a beacon 108, consistent with some embodiments. As shown in FIG. 3, beacon 108 includes a network interface component (NIC) 300 configured for communication with a network such as network 106 shown in FIG. 1. Consistent with some embodiments, NIC 300 includes a wireless communication component, such as a wireless broadband component, a wireless satellite component, or various other types of wireless communication components including radio frequency (RF), microwave frequency (MWF), and/or infrared (IR) components configured for communication 302 with network 106. Consistent with other embodiments, NIC 300 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Beacon 108 also includes a system bus 304 for interconnecting various components within beacon 108 and communicating information between the various components. Such components include a processing component 306, which may be one or more processors, micro-controllers, graphics processing units (GPUs) or digital signal processors (DSPs), a memory component 308, firmware 310 and one or more wireless transceivers 312 that may each include an antenna that is separable or integral and is capable of transmitting and receiving information according to one or more wireless network protocols, such as Wi-Fi™, 3G, 4G, LTE, RF, NFC, IEEE 802.11a, b, g, n, ac, or ad, Bluetooth®, BLE, WiMAX, ZigBee®, ANT or ANT+, etc. In some embodiments, wireless transceivers 312 and network interface component 302 may be part of the same component, or may be separate components. Moreover, network interface component 302 and/or wireless transceivers 312 may also be configured to establish communications with another device using Wi-Fi Direct. In some embodiments, network interface component 302 and wireless transceivers 312 may be capable of communicating with a device based on instructions executed by processing component 306. In other embodiments, network interface component 302 and wireless transceivers 312 may include one or more processors capable of executing instructions for establishing communications and communicating information over an established communication. Beacon 108 may also include a power source 314. Power source 314 may be any power source capable of providing sufficient current to power the components of beacon 108. In some embodiments, power source 318 may be a battery, such as a watch battery or button cell.

In some embodiments, beacon 108 may be configured to transmit information using network interface component 302 and/or wireless transceivers 312 based on instructions stored in memory 308 and/or firmware 310 executed by processing component 306 or by one or more processors in network interface component 302 or wireless transceivers 312. The instructions may be stored in memory 308 and/or firmware 310 by directly writing the instructions to memory 308 and/or firmware 310 over communication link 302 to beacon hardware interface 300 or by wirelessly receiving instructions by wireless transceivers 312. In some embodiments, beacon 108 may be configured to transmit information related to paying for items at a merchant associated with beacon 108. In some embodiments, beacon 108 may also transmit instructions that when received by client computing device 102 may cause payment application 116 to be executed by processing component 206 to cause client computing device 102 to perform a payment at the merchant associated with beacon 108. Further, beacon 108 may be configured to transmit information related to an advertisement or notification. Beacon 108 may also be capable of receiving information about user 110 that may be used to determine advertisements or notifications to present to user 110. Such information may be received from client computing device 102 via an advertised message, or in response to a query sent by beacon 108. Beacon 108 may also be capable of receiving a request for one or more advertisements or notifications that match preferences of user 110.

Beacon 108 may also include a display interface 316 capable of interfacing with display component 109. Display interface 316 may be any combination of hardware and software capable of providing advertisement or notification 111 to display component 109 for display or presentation to user 110. Display interface 316 may be a wired or wireless interface, and may be a USB or HDMI interface, or a bus.

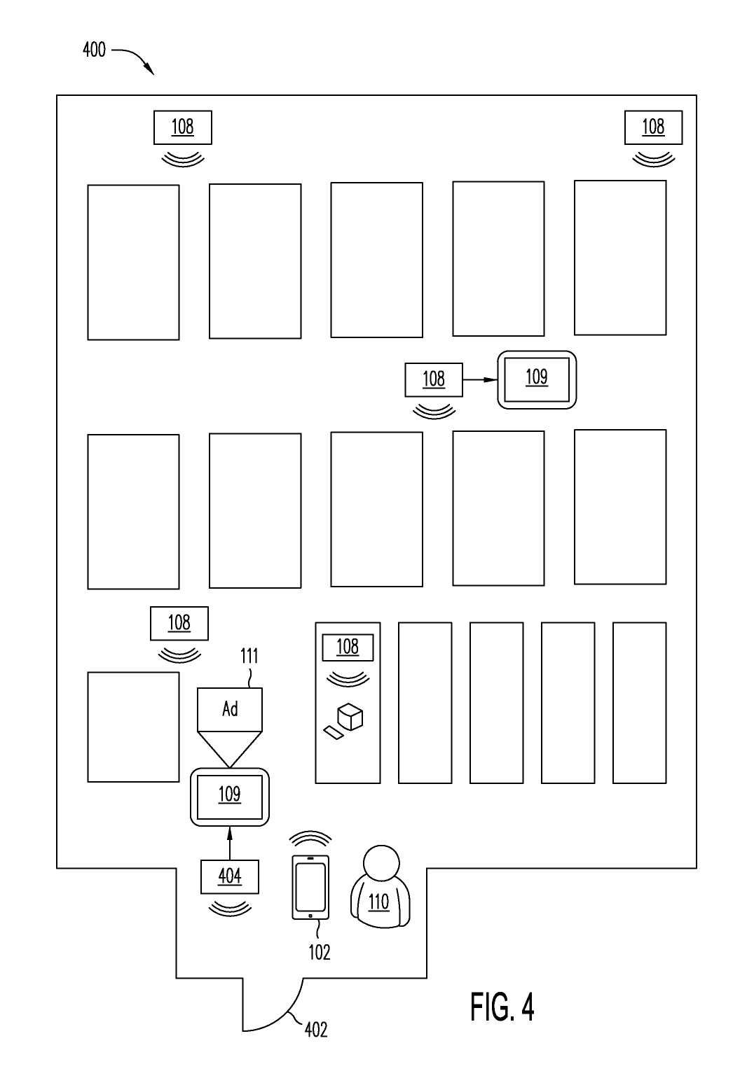

FIG. 4 illustrates in block diagram format an exemplary merchant location 400 and associated system components adapted for displaying a video advertisement or notification to user 110 having client computing device 102, according to some embodiments. It will be readily appreciated that this particular layout of merchant location 400 is only provided for purposes of illustration, and that many other types of layouts, devices, procedures and the like could be effectively implemented using the various principles of the present disclosure.

Merchant location 400 includes an indoor store floor having a number of beacons 108, wherein some beacons 108 may be coupled to and in communication with a display component 109. These devices can be distributed strategically throughout merchant location, such as near the front door 402, at central locations, at registers or points of sale (POS), and/or at locations of high volume traffic within the establishment. One or more client computing devices 102 can interact with one or more of the beacons 108 throughout location 400. Such interaction may include a handshake to establish communications, or may simply include the exchange of information between beacon 108 and client computing device 102 using a wireless communications protocol. Preferably, only one interaction with beacon 108 may be needed to present advertisement or notification 111 to user 110 having client computing device 102, although it may be useful for an establishment to know where user 110 is located and/or where user 110 travels and shopping patterns or habits within location 400. Such further information can be used to provide further advertisements or notifications (e.g., related to something at or near where the user is physically located), and/or to authenticate the actual user versus one who may have stolen or is otherwise using the mobile device in an unauthorized fashion. Such further authentication can involve checking known user 110 traffic and shopping patterns against what is currently happening for a given device 102.

When user 110 having client computing device 102 comes within range of beacon 404, client computing device 102 associated with user 110 may have a low level background program such as payment application 116 running that detects a low level wireless signal from beacon 404. Client computing device 102 can then “wake up” and communicate on a more active level with beacon 108 and, for example, complete a handshake or otherwise communicate information. In some embodiments, a device identifier and token can be generated and assigned to client computing device 102 for a particular time, location and session, with appropriate expiration and other safeguards in place to protect against fraud or other misuse.

In some embodiments, a low-level or background program executing on client computing device 102, such as payment application 116, may cause wireless transceivers 220 of client computing device 102 to determine if available advertisements or notifications advertised by beacon 404 match preferences of user 110 for receiving advertisements or notifications. Consequently, when user 110 having client computing device 102 comes within range of beacon 404, such as may occur when user 110 walks by location 400 or enters location 400 through door 402, client computing device 102 may receive the advertised information from beacon 404 and determine if beacon 404 is able to provide any advertisements or notifications that match preferences of user 110. Client computing device 102 may then initiate communications with beacon 404 and request a matching advertisement or notification. Beacon 404 may receive the request, determine a matching advertisement or notification to present to user 110, retrieve the advertisement or notification, and send the retrieved advertisement or notification to display component 109 which may present advertisement or notification 111 to user 110. In some embodiments, advertisement or notification may be retrieved by beacon 108 from advertisement or notification server 112 or may be retrieved from remote server 104, or may be local stored in memory 308 of beacon. Moreover, displayed advertisement or notification 111 may be personalized for user 110 by any of server 104 or 112 or beacon 108 based on user information included in a request for an advertisement or exchanged during communications.

In some embodiments, client computing device 102 may periodically advertise an identifier that may be used to retrieve preferences of user 110 related to notifications and advertisements. For example, beacon 404 may receive the advertised identifier from client computing device 102, send the advertised identifier to remote server 104 which may have preferences of user 110 stored in account information 124 and be able to retrieve them based on the identifier. In some embodiments, the identifier may be assigned to client computing device 102 by remote server 104 through browser application 115 or payment application 116. The retrieved preferences may then be provided to beacon 404 for determining a relevant advertisement or notification to present to user 110.

Beacon 404 (or any beacon 108 in location 400) may also periodically advertise a query for user preferences which, when received by client computing device 102 may cause client computing device 102 to respond to the query by providing an identifier or information such as preferences related to advertisements or notifications. The response from client computing device 102 may be used by beacon 404 to determine a relevant advertisement or notification, retrieve the relevant advertisement or notification, provide it to display component 109 for display to user 110. In some embodiments, the response may be information including user preferences or an identifier used to retrieve user preferences from, for example, remote server 104.

As user 110 having client computing device 102 moves throughout location 400, client computing device 102 may be in communication with other beacons 108. Some beacons 108 may be coupled to and in communication with a display component 109 and may be able to communicate with client computing device 102 to be able to provide relevant advertisements or notifications to display component 109 for presenting to user 110. In some embodiments, the advertisements may include video advertisements and the notifications may include offers, specials, incentives, and the like. In some embodiments, beacon 108 may be able to provide an advertisement or notification to display component 109 for presenting to user 110 that is related to an area of location 400 at which beacon 108 is located. For example, if beacon 108 is located in a grocery store by soft drinks, when user 110 having client computing device 102 communicates with beacon 108 and requests advertisements relating to soft drinks based on a matching user preference, beacon 108 may determine if advertisements or notifications regarding soft drinks match and, if so, retrieve an advertisement or notification for soft drinks to provide to display component 109 for presenting to user 110. In some embodiments, the retrieval and presentation of an advertisement or notification may be time-based as well as proximity-based, such that beacon 108 may retrieve and provide a relevant advertisement or notification when client computing device 102 has been in communication with beacon for a predetermined amount of time. Further description of the operation of these embodiments are provided with respect to the following figures.

Although the above example is related to user 110 having client computing device 102 moving through location 400, other examples are possible consistent with the embodiments of this disclosure. For example, user 110 may have an RFID transceiver capable of sending limited amounts of information. Beacon 108 may be positioned at a location where user 110 having the RFID transceiver is capable of receiving information about user 110 when user 110 is in range of beacon 108 such that beacon 108 can arrange for displayed advertisement or notification 111 to be presented to user 110 at a predetermined distance away from beacon 108.

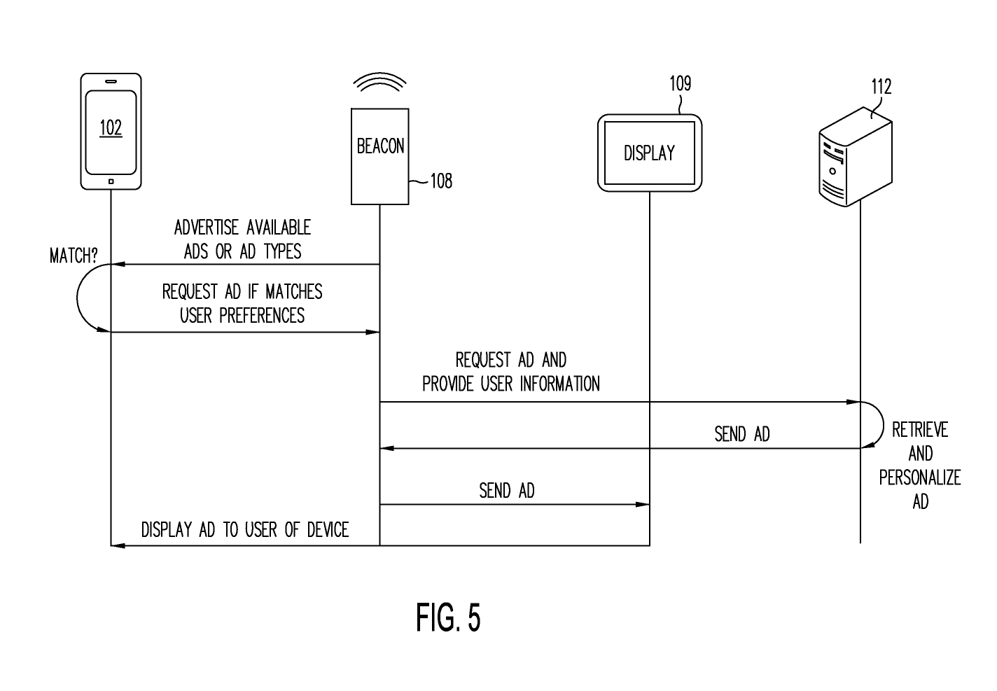

FIG. 5 is a diagram illustrating a first flow for presenting a proximity-based visual notification 111 to user 110, consistent with some embodiments. As shown in FIG. 5, beacon 108 may advertise available advertisements or notifications or available advertisement or notification types. In some embodiments, the advertisement may be sent by beacon 108 periodically looking for any device in range and capable of responding. Client computing device 102 may then determine if the available advertisements or notifications match preferences of user 110. In some embodiments, preferences of user 110 may be stored in memory component 208 of client computing device 102 and processing component 206 of client computing device may be capable of executing instructions for determining if the advertisements or notifications available form beacon 108 match the stored preferences of user 110. In some embodiments, preferences of user 110 may be stored in account information 124 of remote server 104 such that client computing device 102 may be capable of retrieving the preferences over network 106. When client computing device 102 determines that at least one of the advertisements or notifications available from beacon 108 matches a preference of user 110, client computing device 102 may reply to beacon 108 to request an advertisement or notification matching the preferences of user 110. In some embodiments, user 110 may be able to enter preferences using payment application 116 which may store the preferences in memory component 208 or on remote server 104. Payment application 116 may also include instructions for communicating with beacon 108 to establish communications and request a matching advertisement or notification. In some embodiments, the communications between beacon 108 and client computing device 102 may be performed using a BLE communications protocol, or other wireless communication protocol. Moreover, the communications between beacon and client computing device 102 may be performed without requiring interaction with client computing device 102 by user 110.

Based on the received request, beacon 108 may request an advertisement or notification to present to user 110 from advertisement or notification server 112 and, in some embodiments, provide information about user 110 to advertisement or notification server 112 for personalization of the advertisement or notification. Advertisement or notification server 112 may retrieve the determined advertisement or notification and then personalize the advertisement or notification. In some embodiments, personalizing the advertisement or notification may include adding a name of user 110 to the advertisement or notification such that when the advertisement is displayed on display 109, advertisement or notification 111 includes the name of user 110 in the advertisement or notification. Similar personalizations may also be possible. The retrieved and optionally personalized advertisement or notification may then be sent to beacon 108, which may then send the advertisement or notification to display component 109 which may then display advertisement or notification 111 to user 110. In some embodiments, advertisement or notification 111 may be visual, such as a video or an image, and may include associated audio to grab the attention of user 110.

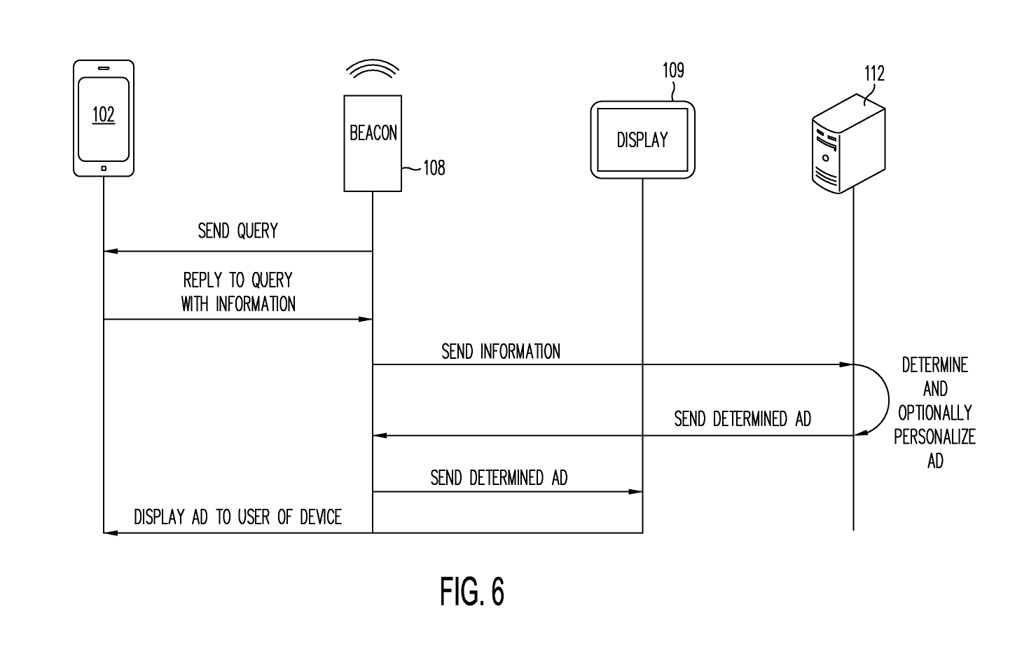

FIG. 6 is a diagram illustrating a second flow for presenting a proximity-based visual notification 111 to user 110, consistent with some embodiments. As shown in FIG. 6, beacon 108 may send a query to client computing device 102 looking for information related to preferences of user 110 for advertisements or notifications. In some embodiments, the query may be sent by beacon 108 periodically looking for any device in range and capable of responding. In some embodiments, the query may be sent by beacon 108 when client computing device 102 begins communicating with beacon 108. Client computing device 102 may then reply to the query with information that includes, for example, preferences of user 110 with respect to advertisements or notifications. In some embodiments, user 110 may be able to enter such information using payment application 116 which may include instructions for communicating with beacon 108 to provide such information. In some embodiments, the communications between beacon 108 and client computing device 102 may be performed using a BLE communications protocol or other wireless networking protocol. Moreover, the communications between beacon and client computing device 102 may be performed without requiring interaction with client computing device 102 by user 110.

Beacon 108 may then send the received information over network 106 to advertisement or notification server 112 which may use the received information to determine an advertisement or notification relevant to the received user information and optionally personalize the advertisement or notification. Advertisement or notification server 112 may then send the determined and optionally personalized advertisement or notification to beacon 108 which may then send the determined and optionally personalized advertisement or notification to display component 109 which may then display advertisement or notification 111 to user 110. In some embodiments, advertisement or notification 111 may be visual, such as a video or an image, and may include associated audio to grab the attention of user 110. In some embodiments, advertisement or notification 111 may be personalized to user 110 by advertisement or notification server 112 based on the received information.

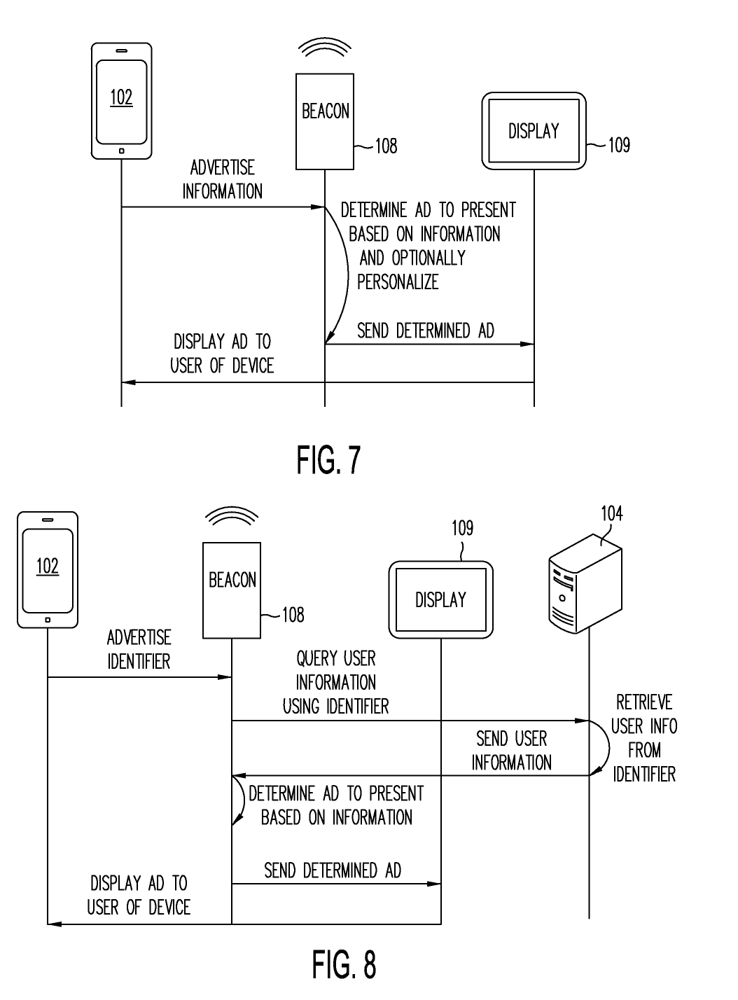

FIG. 7 is a diagram illustrating a third flow for presenting a proximity-based visual notification 111 to user 110, consistent with some embodiments. As shown in FIG. 7, client computing device 102 may advertise information related to preferences of user 110 related to advertisements or notifications. In some embodiments, the advertisements may be made periodically or in response to communicating with beacon 108. Moreover, payment application 116 may include instructions, that when executed, cause client computing device 102 to advertise information. In some embodiments, the communications between beacon 108 and client computing device 102 may be performed using a BLE communications protocol or other wireless communications protocol. Moreover, the communications between beacon and client computing device 102 may be performed without requiring interaction with client computing device 102 by user 110.

Based on the received information, beacon 108 may determine an advertisement or notification to present to user 110, and retrieve the determined advertisement or notification. In some embodiments, beacon 108 may retrieve the determined advertisement or notification from remote server 104, advertisement or notification server 112, or from an internal memory 308 of beacon 108. In some embodiments, when beacon 108 retrieves the determined advertisement or notification, beacon 108 may be capable of personalizing the retrieved advertisement or notifications. In some embodiments, when beacon retrieves the determined advertisement or notification from remote server 104 or advertisement or notification server 112, the server may optionally personalize the advertisement or notification. In some embodiments, personalizing the advertisement or notification may include adding a name of user 110 to the advertisement or notification such that when the advertisement is displayed on display 109, advertisement or notification 111 includes the name of user 110 in the advertisement or notification. Similar personalizations may also be possible. After the optionally personalized advertisement or notification has been determined and retrieved, beacon 108 may send the determined advertisement or notification to display component 109 which may then display advertisement or notification 111 to user 110. In some embodiments, advertisement or notification 111 may be visual, such as a video or an image, and may include associated audio to grab the attention of user 110.

FIG. 8 is a diagram illustrating a flow for presenting a proximity-based visual notification 111 to user 110, consistent with some embodiments. As shown in FIG. 8, client computing device 102 may advertise information, which may include an identifier. In some embodiments, the advertisements may be made periodically or in response to communicating with beacon 108. Moreover, payment application 116 may include instructions, that when executed, cause client computing device 102 to advertise information. In some embodiments, the communications between beacon 108 and client computing device 102 may be using a BLE communications protocol, or other wireless communication protocol. Moreover, the identifier may be an identifier assigned to user 110 and/or client computing device 102. In some embodiments, the identifier may be a media access control (MAC) identifier of client computing device 102.

Based on the received information which may include an identifier, beacon 108 may query user information including preferences of user 110 related to notifications and advertisements based on the received identifier. Remote server 104 may receive the identifier, and retrieve the relevant information of user 110 using the identifier, and send the user information to beacon 108. In some embodiments, the relevant information of user 110 related to advertisements or notifications may be stored in account information 124 of account database 122. When beacon 108 receives the relevant information, beacon 108 may determine an advertisement or notification to present to user 110, and retrieve the determined advertisement or notification. In some embodiments, beacon 108 may retrieve the determined advertisement or notification from remote server 104, advertisement or notification server 112, or from an internal memory 308 of beacon 108. In some embodiments, when beacon retrieves the determined advertisement or notification from remote server 104 or advertisement or notification server 112, the advertisement or notification may be optionally personalized by remote server 104 or advertisement or notification server 112. After the optionally personalized advertisement or notification has been determined and retrieved, beacon 108 may send the determined advertisement or notification to display component 109 which may then display advertisement or notification 111 to user 110. In some embodiments, advertisement or notification 111 may be visual, such as a video or an image, and may include associated audio to grab the attention of user 110.

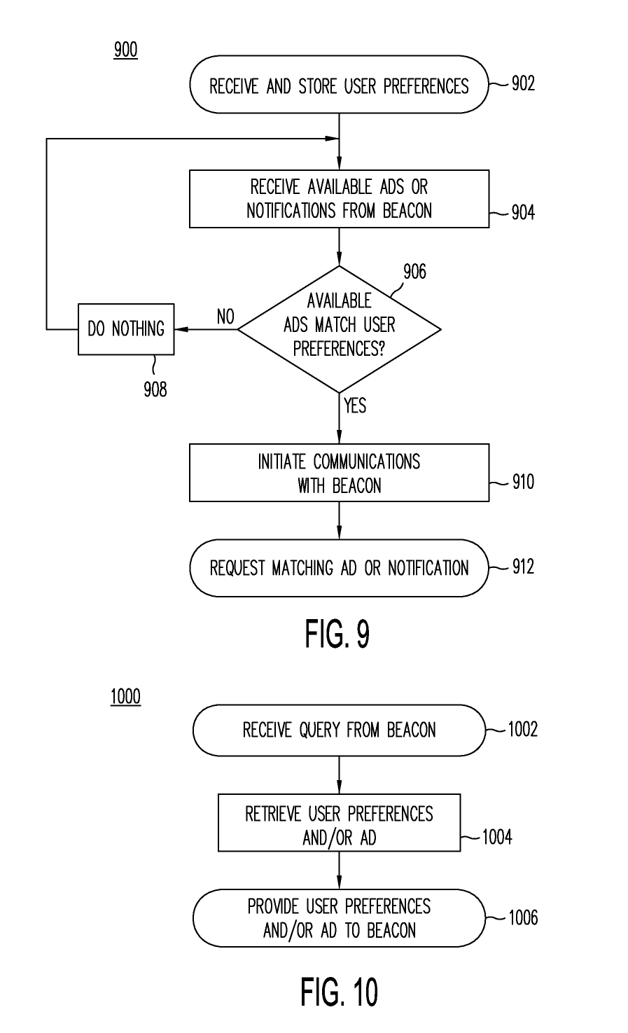

FIG. 9 is a flowchart illustrating a process 900 for providing a proximity-based visual advertisement or notification, consistent with some embodiments. For the purpose of illustration, FIG. 9 may be described with reference to any of FIGS. 1-8. Process 900 shown in FIG. 9 may be embodied in computer-readable instructions for execution by one or more processors such that one or more of the steps of the method may be performed by processing component 206 of client computing device 102. As shown in FIG. 9, process 900 may begin by receiving and storing user preferences (902). In some embodiments the received user preferences may be preferences of user 110 related to receiving advertisements or notifications. Moreover, the preferences may be received by user 110 entering preferences into client computing device 102 using, for example, input component 212. Further, user 110 may be capable of entering the preferences through an interface provided by payment application 116. The received preferences may then be stored. In some embodiments, the received preferences may be stored in memory component 208 of client computing device 102. In some embodiments, the received preferences may be stored by remote server 104 in account information 124 of account database 122. In such embodiments, client computing device 102 executing instructions included in payment application may send the received preferences to remote server 104 for storage. Moreover, remote server 104 may associate an identifier with the stored preferences and may assign the identifier to user 110 and/or client computing device 102 for use in retrieving the stored preferences.

Client computing device 102 may then receive available advertisements or notifications from beacon 108 when client computing device 102 comes into proximity of beacon 108 and is capable of communicating with beacon (904). In some embodiments, beacon 108 may periodically advertise available advertisements or notifications that beacon 108 is able to provide to display component 109 for display to user 110. Communications between client computing device 102 and beacon may be made using a BLE communications protocol or other wireless communications protocol. Client computing device 102 may then determine if any of the available advertisements or notifications available from beacon 108 match the stored preferences of user 110 (906). In some embodiments, processing component 206 may determine if any of the available advertisements or notifications, which including content and type of advertisement or notification, match preferences of user 110, which may be stored in memory component 208 of client computing device 102 or account information 124 of remote server 106 and retrieved by client computing device 102 over network 106. If no advertisements or notifications match preferences of user 110, client computing device 102 will not communicate with beacon 108 and do nothing (908). In some embodiments, as user 110 moves throughout location 400, user 110 may come into the proximity of another beacon 108 and receive available ads or notifications (904) which may match the preferences of user 110.

When client computing device 102 determines that advertisements or notifications available to be displayed match preferences of user 110, client computing device 102 may initiate communications with beacon 108 (910). In some embodiments, initiating communications with beacon 108 may include a handshake or other authentication such that client computing device 102 and beacon 108 can exchange information. Once communications have been initiated with beacon 108, client computing device 102 may request advertisements or notifications that match preferences of user 110 (912). Beacon 108 may then send matching advertisements or notifications to display component 109 for display to user 110. In some embodiments, displayed advertisement or notification 111 may be personalized for user 110 based on information provided to beacon 108 by client computing device 102. Moreover, the personalization of displayed advertisement or notification 111 may be performed at beacon 108 or at advertisement or notification server 112 or, in some cases, remote server 104.

FIG. 10 is a flowchart illustrating a process 1000 for providing user preferences and/or an advertisement or notification to beacon 108, consistent with some embodiments. For the purpose of illustration, FIG. 10 may be described with reference to any of FIGS. 1-8. Process 1000 shown in FIG. 1000 may be embodied in computer-readable instructions for execution by one or more processors such that one or more of the steps of the method may be performed by processing component 206 of remote server 104 and/or advertisement or notification server 112. As shown in FIG. 10, process 1000 may begin when a server, which may be either of remote server 104 or advertisement or notification server 112, receives a query from beacon 108 (1002). The query may be sent to remote server 104 or advertisement or notification server 112 over network 106 and may be a query for user preferences or an advertisement or notification to present to user 110. In some embodiments, the query may be sent to remote server 104 and include an identifier. In other embodiments, the query may be sent to advertisement or notification server 112 and may to request an advertisement or notification based on user preferences.

The server may then retrieve the user preferences and/or the advertisement or notification (1004). In some embodiments, processing component 206 of remote server 104 and/or advertisement or notification server 112 may execute instructions to retrieve the requested user preferences and/or advertisement or notification from memory component 208. Further, if the query received from beacon 108 included an identifier, processing component 206 of remote server 104 may execute instructions to retrieve user preferences from account information 124 of account database 122 using the identifier, such as described above with respect to FIG. 8. Once the server retrieves the user preferences and/or advertisement or notification, the retrieved user preferences and/or advertisement or notification may be provided by the server to beacon 108 (1006). In some embodiments, network interface component 202 of remote server 104 or advertisement or notification server 112 may be capable of sending the retrieved user preferences and/or advertisement or notification to beacon 108 over network 106. Further, if an advertisement or notification was retrieved, the retrieving server may personalize the advertisement or notification before providing the advertisement or notification to beacon 108.

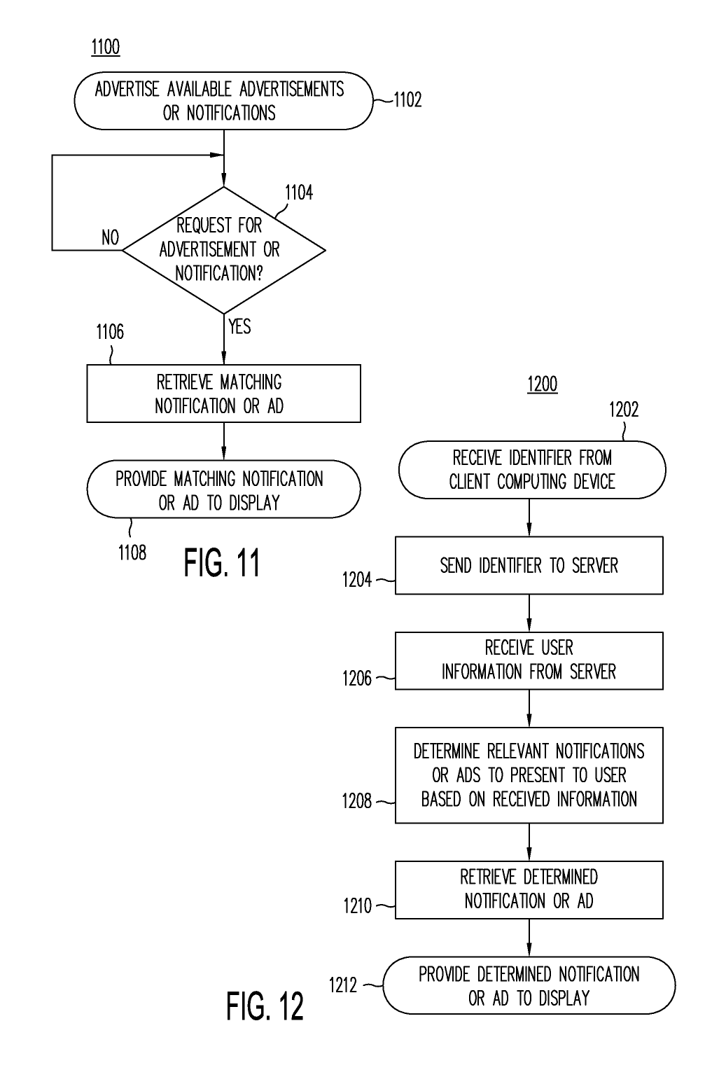

FIG. 11 is a flowchart illustrating a process 1100 for providing an advertisement or notification to display component 109 for presentation to user 110, consistent with some embodiments. For the purpose of illustration, FIG. 11 may be described with reference to any of FIGS. 1-8. Process 1100 shown in FIG. 11 may be embodied in computer-readable instructions for execution by one or more processors such that one or more of the steps of the method may be performed by processing component 306 of beacon 108, which may generally refer to any beacon 108 shown in FIG. 4, including beacon 404. As shown in FIG. 11, process 1100 may begin when beacon begins advertising available advertisements or notifications (1102). In some embodiments, beacon 108 may periodically send out a message that indicates the content and type of advertisements and notifications that are available to be provided to display component 109 for display to user 110. Moreover, the periodic message may be sent using a BLE communications protocol, or other wireless communications protocol.

When a request for an advertisement or notification is received from a client computing device 102 (1104), beacon 108 may then retrieve an advertisement or notification that matches preferences of user 110, as provided by client computing device along with the request (1106). In some embodiments, beacon 108 may retrieve the matching advertisement or notification from memory component 308 of beacon 108, which may have notifications and advertisements stored thereon. In some embodiments, beacon 108 may retrieve the determined advertisement or notification from advertising/notification server 112, and store the retrieved advertisement or notification in memory component 308. Moreover, beacon 108, or the server 104 or 112 from which the advertisement or notification is received may be personalized. Beacon 108 may then provide the matching advertisement or notification to display component 109 through display interface 316 (1108), and display component 109 may then present the displayed advertisement or notification 111 to user 110.

FIG. 12 is a flowchart illustrating a process 1200 for providing an advertisement or notification to display component 109 for presentation to user 110, consistent with some embodiments. For the purpose of illustration, FIG. 12 may be described with reference to any of FIGS. 1-8. Process 1200 shown in FIG. 12 may be embodied in computer-readable instructions for execution by one or more processors such that one or more of the steps of the method may be performed by processing component 306 of beacon 108, which may generally refer to any beacon 108 shown in FIG. 4, including beacon 404. As shown in FIG. 12, process 1200 may begin when beacon 108 receives an identifier from client computing device 102 (1202). In some embodiments, client computing device 102 may periodically advertise an identifier that may be used for retrieving preferences of user 104 relevant to advertisements or notifications. In other embodiments, client computing device 102 may respond to a query from beacon 108 with the identifier. Moreover, identifier may be associated with user 110 and/or client computing device 102, such that preferences of user 110 relevant to advertisements or notifications may be retrieved using the identifier. The identifier may be a MAC address, or other unique identifier. Further, the identifier may be assigned to user 110 and/or client computing device 102 by remote server 104 and may be associated by remote server 104 with the preferences of user 110 relevant to advertisements or notifications. In some embodiments, communications between beacon 108 and client computing device 102, including communications for sending and receiving an identifier, may be made using a BLE communications protocol or other wireless communication protocol.

When beacon 108 receives the identifier, beacon 108 may then send the identifier to remote server 104 (1204). In some embodiments, network interface component 300 of beacon 108 may be capable of sending the identifier to remote server 104 over network 106. Remote server 104 may then retrieve stored preferences of user 110 relevant to advertisements or notifications using the identifier and send the retrieved user preferences to beacon 108 and beacon 108 may then retrieve user information including the user preferences from remote server 104 (1206). Processing component 306 of beacon 108 may then determine relevant advertisements or notifications to present to user 110 based on the received information (1208). In some embodiments, beacon 108 may have a listing of advertisements and notifications stored in memory component 308 and may be capable of determining relevant notifications or advertisement from the stored listing. In some embodiments, beacon 108 may be in communication with advertisement or notification server 112 over network 106 and may be capable of sending search queries to server 112 using the received information to determine relevant advertisements or notifications. Beacon 108 may then retrieve the determined advertisement or notification (1210). In some embodiments, beacon 108 may retrieve the determined advertisement or notification from memory component 308 of beacon 108, which may have notifications and advertisements stored thereon. In some embodiments, beacon 108 may retrieve the determined advertisement or notification from advertising/notification server 112, and store the retrieved advertisement or notification in memory component 308. Beacon 108 may then provide the determined advertisement or notification to display component 109 through display interface 316 (1212), and display component 109 may then present the provided advertisement or notification 111 to user 110.

Automatic Wireless Checkin Methods:

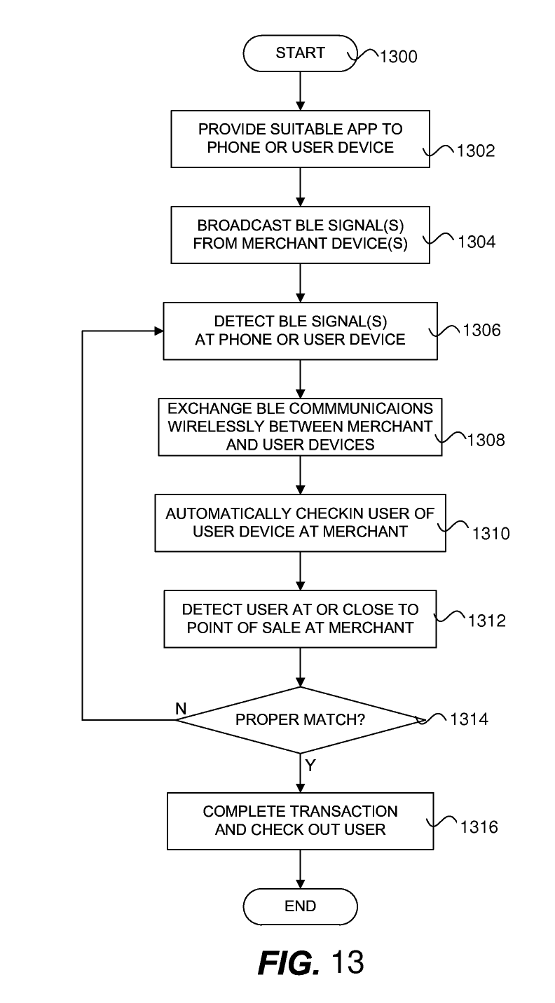

Although a wide variety of applications and methods involving the use of BLE to facilitate automatic wireless consumer checkins might be envisioned, one basic method is illustrated here. Turning next to FIG. 13, a flowchart of an exemplary method of facilitating an automatic wireless consumer checkin is provided. In particular, such a method can involve using or operating any of the various computing components, devices, systems and/or networks described above. It will be readily appreciated that not every method step set forth in this flowchart is always necessary, and that further steps not set forth herein may also be included. Furthermore, the exact order of steps may be altered as desired for various applications.

Beginning with a start step 1300, a first process step 1302 can involve an application, app or other suitable program being provided to a third party user phone or other mobile computing device. Such providing can be performed electronically by a processor, such as on a separately owned server located remotely from the mobile device user. As will be readily appreciated, this providing can be facilitated by the remote processor, such as through an app store or other processor or server owned by another separate party that communicates directly with third party mobile phones and user devices. The app or program can include software code to run a number of functions, including code or information regarding automatic wireless checkins using the phone or other personal mobile device.

At a subsequent process step 1304, suitable BLE signals can be broadcast from one or more merchant controlled devices at a suitable store, merchant or other participating establishment. At least one of these BLE signals can then be detected by the third party mobile phone when it comes within range of the BLE signals at process step 1306. Again, this detection can be accomplished by enabling the third party phone or other mobile computing device to utilize a Bluetooth low energy protocol to detect the presence of a nearby merchant device using the provided software code. This detecting can occur automatically without any affirmative action by the user, as the program or app can run continuously or semi continuously or intermittently in automated fashion in the background and at low energy and bandwidth levels under a BLE protocol.

At the next process step 1308, a wireless communications exchange between the third party phone or mobile computing device and the nearby merchant device can take place. Such an exchange can involve a handshake, exchange of pertinent information and the like, as will be readily appreciated by one of skill in the art. Again, said exchange can occur automatically without any affirmative action by the user of the phone or mobile device. Upon a proper exchange and verification of information, a following process step 1310 can involve the owner or user of the phone or other mobile device being checked into the merchant, either on the merchant computer system, on a remote payment service provider system, or both. Again, this checking in of the user or owner of the user device takes in automatically without any affirmative action by the user.

Additional process steps after checkin can then take place as a result of the automatic checkin. For example, a next step 1312 can involve detecting the user approaching, waiting in line, and/or trying to pay at a register or other point of sale at the merchant or other participating establishment. This step effectively detects the previously checked in user device, which is now close to or in the process of making a purchase or otherwise checking out. A proper matching inquiry can take place at the register or point of sale at decision step 1314. This can involve a register, terminal or bank of same or other point of sale devices detecting numerous checked in user devices at or near a point of sale. One or more automated, manual or mixed processes can then be used to make sure that the right user is being charged for a given transaction, as noted above.

In the event that a proper match cannot be made at step 1314, then the process can revert to process step 1306 in order to checkin the device and user in a manner that can be used. Once a proper match (and recheckin, if necessary) is found or made at inquiry 1314, then the method can continue to process step 1316, where the transaction can be completed, payment or credit can be had, and the user can be checked out. The method then finishes at end step 1318. Further steps not depicted can include, for example, reviewing signal strengths or other personal identifiers as part of the proper matching process at step 1314. Still further steps can include providing offers or advertisements to the known user while he or she is at the participating establishment, assessing for risk in a possible transaction by the known user, extending credit offers, or requiring a PIN or other personal identifier of the user where certain transactions are determined to be more risky than less risky ones. In the event of less risky transactions, a more automated process can allow a user to check out and take goods without any further need for identification, cash, cards, payment, receipts or the like, in a very convenient and streamlined fashion.

Turning lastly to FIG. 14, a flowchart of an exemplary method of performing a handshake between a merchant beacon and a purchaser mobile device on an unencrypted channel so as to facilitate a payment or credit for a purchase according to some embodiments. Again, such a method can involve using or operating a merchant beacon, consumer smart phone, and/or any of the other various computing components, devices, systems and/or networks described above. It will again be readily appreciated that not every method step set forth in this flowchart is always necessary, that further steps not set forth herein may also be included, and/or that the exact order of steps may be altered as desired for various applications.

Beginning with a start step 1400, a first process step 1402 is made with respect to signing up a given user device to a remote service provider, such as Paypal. This can involve installing an application on the user device, registering the user, and initializing the application with the registered user. At this point, the device can then be given a set of advance one-time use payment tokens and associated keys at process step 1404. In some embodiments, the associated keys may include a pair of symmetric keys. These user tokens can each have, for example, a user identifier, a token value, a key serial number and an AES or other crypto key, as will be readily appreciated by one of skill in the art. Such user tokens can be assigned by a backend service provider server, such as that which might be the remote service provider noted above. At process step 1406, records of these assigned keys and user tokens are stored on database(s) at the remote service provider, such that it can be known to the provider who such a token belongs to when it is put into use.

At a following process step 1408, one or more merchant beacons can also be supplied with a digital signatures and merchant one-time use tokens. Each check-in and possible purchase or other transaction can then be tracked using a one-time token from both the user device and a merchant beacon or beacon system that checks in the user device. As in the case of the user device above, the keys and tokens for the beacon are also assigned by and stored at the remote service provider for later reference, which can be done at process step 1410. The user device and beacon are now in condition for communications, check-ins and transactions.

At a subsequent process step 1412, a generic UUID is constantly broadcast from the beacon. This UUID is detected and verified as issued by the same service provider by the user device at process step 1414. The user device and beacon then initiate communications, whereupon metadata, a specific one-time use beacon token, and a digital signature can be sent from the beacon to the user device at process step 1416. The application on the user device can then certify the beacon token and verify the digital signature as being issued by the service provider by using a public key from the service provider at process step 1418. Assuming that the beacon token sent over is authentic, the user device then selects one of its assigned one-time use user tokens at process step 1420.

At a following process step 1422, the user device then encrypts both its user token value and the beacon token value together using the key associated with the user token, and then sends this encrypted value back to the beacon, where it is received at process step 1424. Again, all of these communications between the user device and the beacon can be on an unencrypted channel, as any other outside device that might be listening or noting these open communications will not know what to make of the token values without any reference table that knows where those tokens were assigned. In fact, the beacon itself does not know what to make of the combined encrypted value. Rather, the beacon simply forwards this value on a back channel to the remote service provider server at process step 1426. The remote server knows what to do with these values, since it has the details of where and to whom all tokens were assigned in various tables or other storage mechanisms on its database(s).

As such, the remote server decrypts the combined encrypted value at process step 1428 and verifies the authenticity and ownership of both the user token and the beacon (i.e., merchant) token. The remote server then approves of the user device and provides affirmative check-in instructions back to the beacon at process step 1430. It is worth noting that while the communications between the user device and the beacon over BLE are unencrypted, the communications between the beacon and the remote server are on a separate more protected channel. Neither the user device nor any other device need see these communications between beacon and remote server of the service provider. As the user device is then checked in and the one time use tokens for the user device and beacon are both committed to this checkin and any resulting transaction, one or more new tokens can then be optionally provided to the user device and/or the beacon at process step 1432. The remote server then marks both of these tokens as used on its databases at process step 1434, whereupon the “handshake” checkin process or method then ends at end step 1436.

In various embodiments, many respective one-time use tokens can be stored on each of the various user devices and/or beacons at any given time. Selection of a given token from the pool of possible tokens can then be random, which adds some layer of protection from potential fraud or misuse. Further, the requirements that each token be used one time only, and that the combined encrypted token values be verified by the backend provider server tends to prevent or reduce the possibility of token replay or bit fiddling by unscrupulous persons who might otherwise try to make something of the unencrypted and open communications over BLE channels. Again, these tokens can be replenished one at a time as they are used and discarded or otherwise rendered unusable, such as by part of a check in process. Alternatively, or in addition, each user device and/or beacon can also request more tokens from the remote service provider server independently as needed.

Other safety mechanisms to provide better security can include expiration dates on each token, as well as a requirement that the user device be in constant communication with one or more beacons at the merchant from checkin through any checkout and purchase or other transaction. In the event that communications are lost or dropped, then a new checkin with new tokens may be required if desired for security purposes. Further, it is also worth noting that the third party user device does not need to access the private keys of any beacon. Rather, the public keys are all that are necessary for the backend server to verify and authenticate tokens for both the user device and the beacon for checkin and later transaction. In some embodiments, there may be only one pair of public and private keys for all beacons at all merchants, with the private key being on the backend server, and the public key being provided to the mobile device.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Embodiments disclosed herein may allow targeted advertisements or notifications to be presented to a user in the proximity of a wireless device having or being coupled to a display based on defined user preferences for receiving advertisements or notifications The examples provided above are exemplary only and are not intended to be limiting. One skilled in the art may readily devise other systems consistent with the disclosed embodiments which are intended to be within the scope of this disclosure. As such, the application is limited only by the following claims.

1-20. (canceled)

21. A method for providing payment and advertisement/notification services to mobile devices, the method comprising:
broadcasting over a wireless network, by at least one beacon of a beacon system of one or more beacons located in a first area, first wireless signals detectable by wireless devices, the wireless network having a range limited to the first area, the first wireless signals having a reach restricted to the first area, the beacon system being associated with at least one display which is located in the first area and which is operable to receive from the beacon system, and to display, advertisements or notifications for users of wireless mobile devices;
receiving, by the beacon system over the wireless network, a response to the first wireless signals from a first mobile device located in the first area, the first mobile device being a wireless mobile device of a first user;
performing, by the beacon system, a cryptographic wireless payment checkin operation for checking in the first mobile device and/or the first user to a payment service, wherein the cryptographic wireless checkin operation is part of an automatic wireless payment checkin service performed without any affirmative action by the first user, and the cryptographic wireless checkin operation comprises:
receiving, by the beacon system over the wireless network from the first mobile device, cryptographic authentication data for the payment service; and
communicating, by the beacon system, with a remote computer system of the payment service and using the cryptographic authentication data to perform cryptographic authentication for a subsequent wireless payment through the first mobile device in case the first mobile device is used for wireless payment via the payment service;
wherein the method further comprises:
determining, by the beacon system, one or more advertisements or notifications that match a profile of the first user while the first mobile device is in the first area and in communication with the beacon system over the wireless network; and
while the first mobile device is in the first area and in communication with the beacon over the wireless network, providing, by the beacon system, the one or more advertisements or notifications that match the profile of the first user to a display located in the first area, for displaying the one or more advertisements or notifications to the first user.

22. The method of claim 21 wherein the first wireless signals advertise said automatic wireless payment checkin service.

23. The method of claim 21 wherein said range of the wireless network is about 50 meters.

24. The method of claim 21 wherein the cryptographic authentication data comprise an encryption of a value comprising a one-time use token assigned to the first mobile device.

25. The method of claim 24 wherein said value also comprises a beacon token assigned to a beacon in the beacon system.

26. The method of claim 24 further comprising decrypting the cryptographic authentication data to obtain the one-time use token of the first mobile device, and authenticating the one-time use token.

27. The method of claim 21 wherein said determining one or more advertisements or notifications comprises:
sending by the beacon system to the first mobile device, over the wireless network, data identifying available advertisements or notifications or available advertisement or notification types; and
receiving by the beacon system from the first mobile device, over the wireless network, a request for advertisements or notifications determined as those available advertisements or notifications or available advertisement or notification types which match the first user's preferences.

28. The method of claim 21 wherein said determining one or more advertisements or notifications comprises receiving by the beacon system the first user's preferences from the remote server in response to the beacon system sending to the remote server an identifier received from the first mobile device.

29. The method of claim 21 further comprising making the wireless payment using the wireless payment checkin service, wherein the wireless payment is made, in part, through a communication between the first mobile device and the remote computer while the first mobile device is in the first area.

30. A beacon comprising:
a memory storing computer instructions;
one or more processors capable to execute the computer instructions; and
network interface circuitry comprising one or more wireless transceivers for communicating over a wireless network having a range limited to a first area operable to include a display and exclude a remote computer system, the network interface circuitry further operable to communicate with the remote computer system;
wherein the beacon is configured to perform a method for providing payment and advertisement/notification services to mobile devices, the method comprising:
broadcasting over the wireless network first wireless signals detectable by wireless devices, the wireless network having a range limited to the first area, the first wireless signals having a reach restricted to the first area, the beacon being associated with the display which is located in the first area and which is operable to receive from the beacon, and to display, advertisements or notifications for users of wireless mobile devices;
receiving, over the wireless network, a response to the first wireless signals from a first mobile device located in the first area, the first mobile device being a wireless mobile device of a first user;
performing a cryptographic wireless payment checkin operation for checking in the first mobile device and/or the first user to a payment service, wherein the cryptographic wireless checkin operation is part of an automatic wireless payment checkin service performed without any affirmative action by the first user, and the cryptographic wireless checkin operation comprises:
receiving over the wireless network, from the first mobile device, cryptographic authentication data for the payment service; and
communicating with a remote computer system of the payment service and using the cryptographic authentication data to perform cryptographic authentication for a subsequent wireless payment through the first mobile device in case the first mobile device is used for wireless payment via the payment service;
wherein the method further comprises:
determining one or more advertisements or notifications that match a profile of the first user while the first mobile device is in the first area and in communication with the beacon over the wireless network; and
while the first mobile device is in the first area and in communication with the beacon over the wireless network, providing the one or more advertisements or notifications that match the profile of the first user to a display located in the first area, for displaying the one or more advertisements or notifications to the first user.

31. The beacon of claim 30 wherein in the method, the first wireless signals advertise said automatic wireless payment checkin service.

32. The beacon of claim 30 wherein said range of the wireless network is about 50 meters.

33. The beacon of claim 30 wherein the cryptographic authentication data comprise an encryption of a value comprising a one-time use token assigned to the first mobile device.

34. The beacon of claim 33 wherein said value further comprises a beacon token assigned to the beacon.

35. The beacon of claim 33, wherein the method further comprises decrypting the cryptographic authentication data to obtain the one-time use token of the first mobile device, and authenticating the one-time use token.

36. The beacon of claim 30 wherein said determining one or more advertisements or notifications comprises:
sending to the first mobile device, over the wireless network, data identifying available advertisements or notifications or available advertisement or notification types; and
receiving from the first mobile device, over the wireless network, a request for advertisements or notifications determined as those available advertisements or notifications or available advertisement or notification types which match the first user's preferences.

37. The beacon of claim 30 wherein said determining one or more advertisements or notifications comprises receiving by the beacon system the first user's preferences from the remote server in response to the beacon system sending to the remote server an identifier received from the first mobile device.

38. A computer readable medium comprising instructions for execution by one or more processors of a beacon which comprises, in addition to the one or more processors, network interface circuitry comprising one or more wireless transceivers for communicating over a wireless network having a range limited to a first area operable to include a display and exclude a remote computer system, the network interface circuitry further operable to communicate with the remote computer system;
wherein when executed by the one or more processors, the instructions cause the beacon to perform a method for providing payment and advertisement/notification services to mobile devices, the method comprising:
broadcasting over the wireless network, by the beacon, first wireless signals detectable by wireless devices, the wireless network having a range limited to the first area, the first wireless signals having a reach restricted to the first area, the beacon being associated with the display which is located in the first area and which is operable to receive from the beacon, and to display, advertisements or notifications for users of wireless mobile devices;
receiving, over the wireless network, a response to the first wireless signals from a first mobile device located in the first area, the first mobile device being a wireless mobile device of a first user;
performing a cryptographic wireless payment checkin operation for checking in the first mobile device and/or the first user to a payment service, wherein the cryptographic wireless checkin operation is part of an automatic wireless payment checkin service performed without any affirmative action by the first user, and the cryptographic wireless checkin operation comprises:
receiving over the wireless network, from the first mobile device, cryptographic authentication data for the payment service; and
communicating with a remote computer system of the payment service and using the cryptographic authentication data to perform cryptographic authentication for a subsequent wireless payment through the first mobile device in case the first mobile device is used for wireless payment via the payment service;
wherein the method further comprises:
determining one or more advertisements or notifications that match a profile of the first user while the first mobile device is in the first area and in communication with the beacon over the wireless network; and
while the first mobile device is in the first area and in communication with the beacon over the wireless network, providing the one or more advertisements or notifications that match the profile of the first user to a display located in the first area, for displaying the one or more advertisements or notifications to the first user.

39. The computer readable medium of claim 38 wherein in the method, the first wireless signals advertise said automatic wireless payment checkin service.

40. The computer readable medium of claim 38 wherein said range of the wireless network is about 50 meters.

41. The computer readable medium of claim 38 wherein the cryptographic authentication data comprise an encryption of a value comprising a one-time use token assigned to the first mobile device.

42. The computer readable medium of claim 41 wherein said value further comprises a beacon token assigned to the beacon.

43. The computer readable medium of claim 41 wherein the method further comprises decrypting the cryptographic authentication data to obtain the one-time use token of the first mobile device, and authenticating the one-time use token.

44. The computer readable medium of claim 39 wherein said determining one or more advertisements or notifications comprises:
sending to the first mobile device, over the wireless network, data identifying available advertisements or notifications or available advertisement or notification types; and
receiving from the first mobile device, over the wireless network, a request for advertisements or notifications determined as those available advertisements or notifications or available advertisement or notification types which match the first user's preferences.

45. The method of claim 44 wherein said determining one or more advertisements or notifications comprises receiving by the beacon system the first user's preferences from the remote server in response to the beacon system sending to the remote server an identifier received from the first mobile device.
